(19) United States
(12) Patent Application Publication
(10) Pub. No.: US 2003/0004681 A1
(43) Pub. Date: Jan. 2, 2003

(54) Method for operating a technical facility

(76) Inventors: Jorg Fandrich, Obermichelbach (DE); Jorg Gassmann, Igensdorf (DE); Andre Gerlach, Weisswasser (DE)

Correspondence Address: HARNESS, DICKEY & PIERCE, P.L.C., P.O.BOX 8910, RESTON, VA, 20195, US

(21) Appl. No.: 10/203,812

(22) PCT Filed: Feb. 2, 2001
(86) PCT No.: PCT/DE01/00418

(30) Foreign Application Priority Data
Feb. 14, 2000 (DE) 10006455-8

(51) Int. Cl. G06F 11/30; G06F 15/00; G21C 17/00

(52) U.S. Cl. 702/183

(57) ABSTRACT

The invention concerns a method for operating a technical facility (2) comprising an expert system (1) for diagnosing (9) the operating state of the technical facility (2). Once the expert system (1) has identified a malfunction of the technical facility (2), the expert knowledge available in the knowledge base (WB) of the expert system (1) is also used parallel to the establishment of a diagnosis (9) to calculate a regulatory intervention (u) in the technical facility (2) with the purpose of automatically eliminating a malfunction.

The invention relates to a method for operating a technical facility with an expert system for diagnosing the operating state of the technical facility. The technical facility is preferably a power plant for generating electrical energy.

In many modern technical facilities, for example power plants, expert systems are used for diagnosing the operating state, in order to give the operators assistance in operating the power plant—in particular in the event of a malfunction. The diagnoses prepared by an expert system usually give information on the type of malfunction, the location of its occurrence and possible measures to rectify it. The operator is thereby relieved of the task of recognizing possible operative interrelationships and, as a result, assisted in rectifying a malfunction. The expert system in this case contains what is known as expert knowledge as a knowledge base, which is then used for ascertaining the diagnoses.

In DE 43 38 237 A1, a method and a device for analyzing a diagnosis of an operating state of a technical facility are specified. In this case, a symptom tree is set up, with which a path is activated and a diagnostic text output according to the malfunction. Rules, symptom definitions and diagnostic texts are stored in a data memory. The representation of all the logical components of the diagnosis and their interlinking structure makes it possible to trace back the diagnosis and consequently analyze it. It is therefore possible to trace the diagnosis right through all the active rules contributing to it. As a result, the operator has the most compressive possible overview of the operative interrelationships of the currently existing malfunction and can then take specific countermeasures against the malfunction by performing manual switching operations. A disadvantage of this method is that it is the responsibility of the operator to develop suitable strategies to eliminate the malfunction and initiate countermeasures; in particular in the case of time-critical operations, this easily becomes too much to expect from a person.

In DE 4 421 245 A1, a device for simulating the operation of a technical facility is described. The device contains a program-assisted simulation module and rules concerning the technical knowledge. The simulation input data are used to form symptoms, which are fed to the simulation module and the latter uses them to produce a diagnosis. The processing of the data within the device can in this case be observed step by step. Depending on the diagnosis produced, finally the feedback to the simulated operation of the facility can be carried out. It is not possible in this case to trace back in detail which changes in the operating state of the technical facility are brought about by the feedback measures taken to correspond to the diagnosis.

In the aforementioned document, no references are made to the strategies which could be used in the feedback of the diagnosis to the simulated process to restore desired normal operation.

The invention is based on the object of specifying a method for operating a technical facility with an expert system for diagnosing the operating state of the technical facility which relieves the operator of the task of reliably and quickly counteracting the malfunction by performing intelligent manual switching operations.

According to the invention, the method of the type stated at the beginning comprises the following steps:

1. In the expert system, a malfunction is identified, automatically triggering a regulating intervention in the technical facility.

2. At least one knowledge base available in the expert system is used—in parallel with the diagnosis—to establish the regulating intervention.

3. The regulating intervention in the technical facility is continued until the system deviation lies in a specified tolerance band.

The simultaneous use of the knowledge base of the expert system for diagnosis and regulating intervention in the technical facility means that the existing expert knowledge is systematically utilized and two-track considerations, which would be necessary in the case where the diagnosis and creation of a regulating intervention are carried out separately, largely become superfluous and the sources of error possibly arising as a result are eliminated. In addition, by dealing with the diagnosis and regulating intervention together, the relationship between the two can be presented very clearly and well, for example on the control screen of the operator of a technical facility. In addition, a broadening of the diagnostic possibilities can also be used at the same time to improve the regulating intervention.

In a further refinement of the invention, the expert system produces the diagnosis by means of measured values from the technical facility and the regulating intervention is established at least from one of the measured values and/or a variable derived from the measured values. It is consequently possible to use the same database of measured values as a basis for producing the diagnosis and establishing the regulating intervention.

The system deviation and/or the change in it is advantageously formed as variables derived from the measured values. Here, too, a database of the measured values can be used both for producing the diagnosis and for establishing the regulating intervention.

The knowledge base advantageously establishes the regulating intervention completely. This means that only a single knowledge base has to be used for performing both tasks—diagnosis and regulating intervention to eliminate the malfunction.

A preferred embodiment of the invention consists in that the knowledge base of the expert system is formulated according to methods of fuzzy logic. Expert systems in which a modeling of the knowledge is possible on the basis of methods of this type are commercially available (for example DIWA or DIGEST from Siemens AG). The use of an expert system of this type makes it possible to concentrate on the important task of preparing a technological knowledge base and removes the need for considerations with regard to the formalisms involved in the formulation of the knowledge base.

The fuzzy logic used when formulating the knowledge base advantageously contains specific, linguistic IF . . . THEN rules. The procedure for formulating rules of this type is known. The knowledge for both the diagnosis and the regulating intervention can in this way be acquired and processed together.

The system deviation and/or variables derived from it are advantageously fuzzified. This is understood as meaning the conversion of physically relevant input values into what are known as membership values. The membership values in turn determine the degree of rule activation. Details and principles of fuzzy logic can be taken for example from Hans-Heinrich Bothe: “Neuro-Fuzzy-Methoden” [neuro fuzzy methods], Springer, Berlin et al., 1998. A further relevant literature source is, for example, Dimiter Driankov et al.: “An Introduction to Fuzzy Control”, Springer, Berlin, Heidelberg, 1998. The fuzzification of the variables mentioned has the advantage that the variables prepared in this way can then be processed in a fuzzy controller for ascertaining the regulating intervention. In this way, both tasks—diagnosis and ascertaining a regulating intervention—can be performed with one and the same means, the variables necessary for ascertaining the regulating intervention also being available in a preferred form.

Three exemplary embodiments of the invention are explained on the basis of the accompanying drawings, in which:

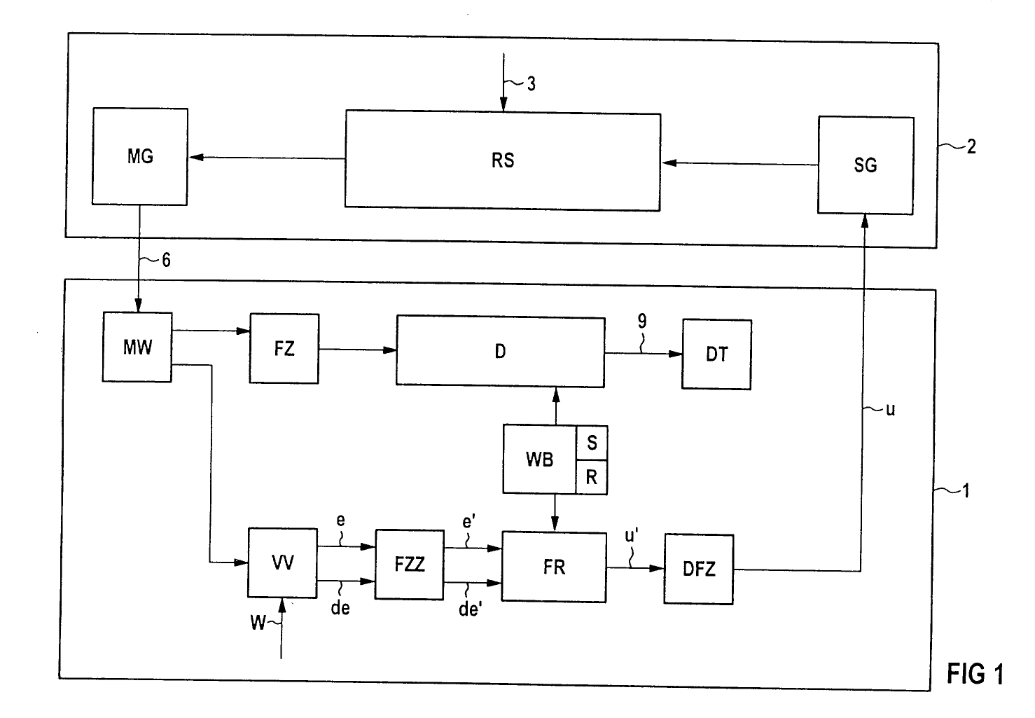

FIG. 1 shows a schematic representation of the most important components of an expert system connected to a technical facility for simultaneously producing diagnoses of the operating state of the technical facility and determining a regulating intervention in the technical facility,

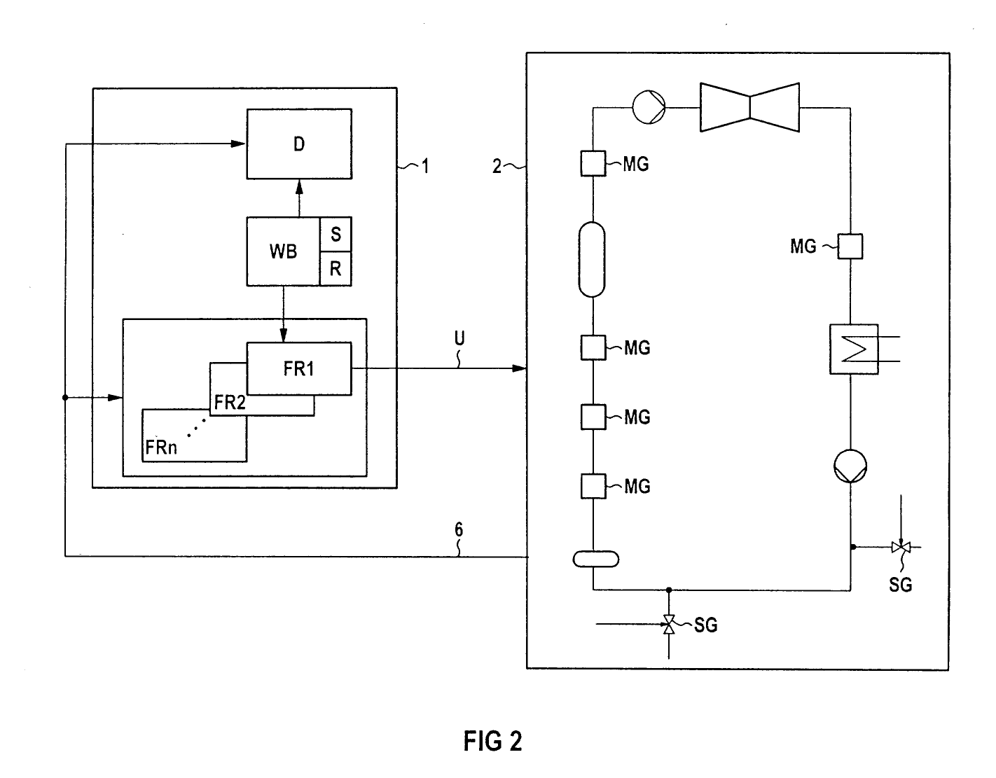

FIG. 2 shows a technical facility with the associated controllers and diagnostic system, and

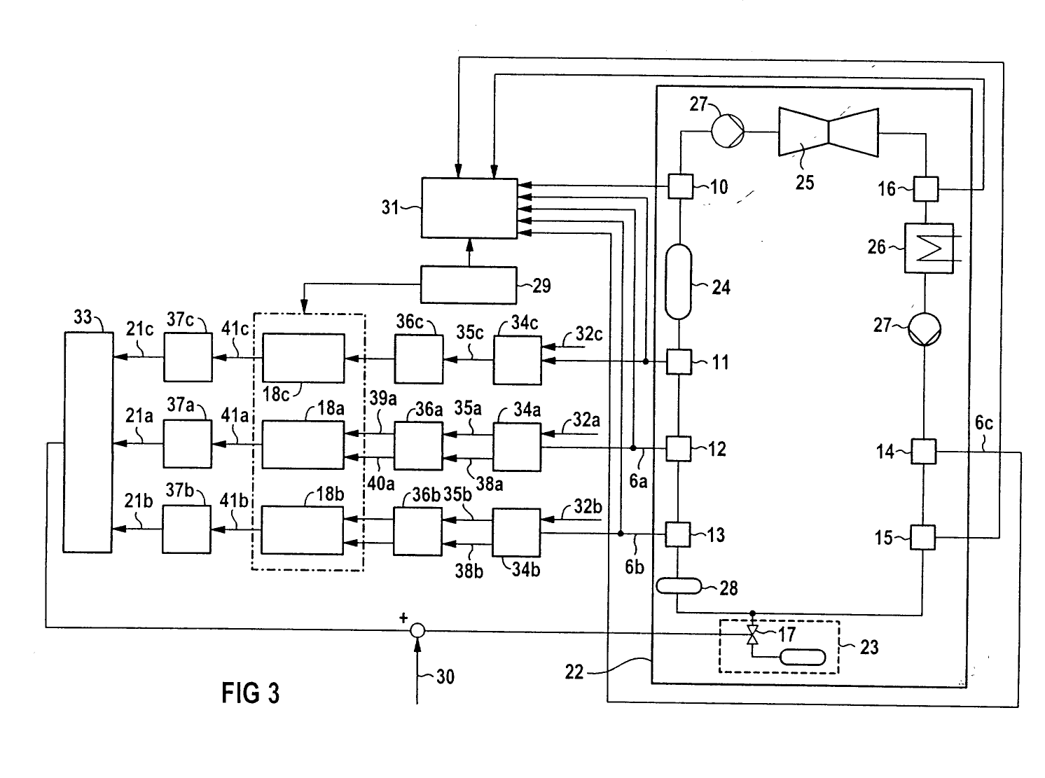

FIG. 3 shows a water-steam cycle of a technical facility, a diagnosis by the expert system of a problematical entry of oxygen being followed by an automatic metered introduction of hydrazine to prevent the impending corrosion of important components of the water-steam cycle.

FIG. 1 shows an expert system 1, which is connected to a technical facility 2. The expert system in this case performs the tasks of diagnosing the operating state and determining a regulating intervention for automatically rectifying a malfunction. The technical facility in this case comprises one or more controlled systems RS, one or more measuring elements MG and one or more final controlling elements SG. It is indicated by 3 that the controlled systems RS can be affected not only by the manipulated variables specified by the final controlling elements SG but also by disturbances, which may not even be registered by measuring instruments. The measuring elements MG supply measured values 6 to the expert system 1, which are stored there in a database MW. The measured values are fuzzified according to known methods in a processing stage FZ. A knowledge base WB contains symptoms S and rules R, which are formulated on the basis of technological expert knowledge according to known methods of fuzzy logic. On the basis of the currently existing, fuzzified measured values and the symptoms S and rules R of the knowledge base WB, a diagnosis 9 of the current operating state of the technical facility is produced in a diagnostic logic unit D and displayed as a diagnostic text in a display unit, for example a diagnostic field DT of a screen image. The database MW also supplies in parallel with the diagnostic unit D a preprocessing stage VV of a fuzzy controller with measured values 8, which are processed by the fuzzy controller FR to form the regulating intervention in the technical facility. In the preprocessing stage W, the variables used for the regulation, the system deviation e and the change de in the system deviation e, are formed, the setpoint value w of a variable to be regulated also being used. The variables comprising the system deviation e and change de in the system deviation e are subsequently fuzzified according to known methods in a further processing stage FZZ and fed as fuzzified variables e′ and de′ to the controller FR. This controller FR is designed as a fuzzy controller, which accesses the same knowledge base WB as is also used for producing the diagnosis 9. The fuzzy controller FR supplies a fuzzified manipulated variable u′, which is converted into a sharp output value u in a further processing stage DFZ by subsequent defuzzification. This sharp output value u is used for driving at least one of the final controlling elements SG of the technical facility. The regulating intervention in the technical facility continues until a desired normal state is reached.

FIG. 2 shows the normal case that the technical facility 2 has a plurality of measuring elements MG and final controlling elements SG. Connected to this technical facility 2 is the expert system 1, which diagnoses the operating state of the technical facility and, in the event of a malfunction, performs one or more regulating interventions u in the technical facility 2. The operating state of the technical facility is transmitted to the expert system 1 by means of measured values 6, which are supplied to the technical facility 2 by the measuring elements MG.

The expert system 1 comprises the main components that are the diagnostic unit D, the knowledge base WB and one or more fuzzy controllers FR1 to FRn. The expert system 1 produces a diagnosis of the operating state of the technical facility 2 on the basis of the symptoms S and rules R contained in the knowledge base. If a malfunction is identified, one or more regulating interventions u in the technical facility 2 are automatically triggered by at least one of the fuzzy controllers FR1 to FRn. The fuzzy controller or controllers use the same knowledge base WB as is also used for producing the diagnoses as a basis for forming one or more manipulated variables u. The manipulated variables u produced by the fuzzy controller or controllers act on the final controlling element or elements SG of the technical facility 2, so that a normal state is restored. The entire technical facility 2 is consequently monitored by the expert system 1, diagnoses of the operating state are produced and, in the event of an identified malfunction, one or more regulating interventions u in the technical facility 2 are automatically carried out by the fuzzy controller or controllers, until a desired normal state is restored. In this way, malfunctions triggered by faults in the technical facility 2 are automatically corrected.

FIG. 3 shows a water-steam cycle 22 of a technical facility, a diagnosis by the expert system of a troublesome entry of oxygen being followed by actuation of an automatic metering device 23, which feeds hydrazine into the water-steam cycle 22 to prevent impending corrosion of important components. The water-steam cycle 22 comprises the main components that are the steam generator 24, turbine 25, condenser 26, one or more pumps 27, feed water tanks 28, measuring elements 10 to 16 and a metering valve 17 as a final controlling element of the metering device 23. A possible entry of oxygen into the water-steam cycle 22 as the result of a leakage represents a malfunction which causes the problem of corrosion of important parts of the facility in the water-steam cycle 22. The consequences of such an entry of oxygen can be eliminated by metered introduction of hydrazine—chemical formula N₂H₄—, which bonds with the oxygen present in the water-steam cycle 22 as a result of the leakage and stops this oxygen from setting off a chemical corrosion reaction. When metering in hydrazine, it should be ensured that no more hydrazine than is necessary is metered in, since excess hydrazine causes a further problem, that is the uptake of iron as a suspended substance, and the associated impending deposition of suspended iron particles, in particular in the steam generator 24. A compromise between reliable neutralization of the corrosive effect of oxygen by plentiful introduction of hydrazine and best possible prevention of the incorporation of suspended iron particles is therefore to be aimed for.

The measuring elements 10 to 16 which are distributed in the water-steam cycle 22 of the technical facility supply measured values concerning the operating state to the expert system. The measured value 6a of the oxygen concentration in the feed water upstream of the steam generator 24, which can be picked up at the measuring element 12, the measured value 6b of the redox potential, which is a measure of the concentration of the hydrazine located in the water-steam cycle 22 and can be obtained at the same point at the measuring element 13, and the measured value 6c of the oxygen concentration downstream of the condenser 26, available at the measuring element 14, are essentially the values used for diagnosing a troublesome entry of oxygen into the water-steam cycle 22 of the technical facility. The other measuring elements serve essentially for measuring cation conductivity; the measured values obtained there are additional criteria which confirm that oxygen has entered the water-steam cycle 22, and localize the place where the oxygen is entering. In normal operation, a relatively high concentration of hydrazine provides a low oxygen content and acts as a buffer to keep the oxygen content low even in the event of air entering. This hydrazine reserve (“hydrazine buffer”) is of a size which is established according to the operating experience obtained with the technical facility. It is to be endeavored to maintain this hydrazine buffer, which represents a safeguard against corrosion of important components of the water-steam cycle, even in the event of a malfunction, to avoid corrosion as reliably as possible.

The expert system receives the previously mentioned measured values. If oxygen concentrations 6a and 6c which lie above the values of normal operation are measured in the measuring elements 12 and 14, and the measured value 6b of the redox potential at the measuring element 13 falls, these are indications of the malfunction of oxygen entering the water-steam cycle 22. The expert system produces a malfunction diagnosis from these measured values—with the assistance of additional measured values of the cation conductivity in the water-steam cycle 22 at the measuring elements 10, 11, 15 and 16—, use being made of the symptoms and rules contained in the knowledge base 29 to produce the diagnosis. The measured values 6a, 6b and 6c of the oxygen concentrations and the redox potential are also transferred in parallel to three fuzzy controllers 18a, 18b and 18c, which, after identification by the expert system of a troublesome entry of oxygen, automatically calculate regulating interventions 21a, 21b and 21c with respect to the final controlling element 17 of the metering device 23. All three fuzzy controllers—which are also supplied with the required setpoint values 32a, 32b and 32c—make use in this case of the symptoms and rules present in the knowledge base 29, which are also used for producing the malfunction diagnosis, to produce the respective regulating intervention.

The first fuzzy controller 18c processes the measured value 6c of the oxygen concentration in the water-steam cycle downstream of the condenser 26 and, after identification of a malfunction, calculates the regulating intervention 21c with respect to the final controlling element 17 for the hydrazine metering device 23. An examination of the controlled system to be regulated by this first fuzzy controller 18c reveals that, for forming the regulating intervention 21c, it is adequate to form the system deviation 35c in the preprocessing stage 34c of this first controller, to fuzzify it in the processing stage 36c and to process it further in the controller. The controller calculates a fuzzified manipulated variable 41c, which is subsequently defuzzified in the processing stage 37c, i.e. converted into a sharp value for the regulating intervention 21c.

The second fuzzy controller 18a processes the measured value 6a of the oxygen concentration in the feed water upstream of the steam generator. On account of the somewhat more complicated structure of the controlled system to be regulated by this second fuzzy controller 18a, the system deviation 35a and its change 38a are calculated in the associated preprocessing stage 34a and subsequently fuzzified in the processing stage 36a. The change 38a in the system deviation 35a is in this case made up of a differentiated component and an integrated component, which provide information on the past behavior of the system deviation 35a. The second fuzzy controller 18a calculates from the fuzzified variables comprising the system deviation and change in the system deviation 39a and 40a respectively the regulating intervention 21a with respect to the final controlling element 17 of the hydrazine metering device 23. In this case, the second fuzzy controller 18a initially calculates a fuzzified manipulated variable 41a, which is then converted in a processing stage 37a into a sharp value for the regulating intervention 21a. To determine the regulating intervention 21a, the second fuzzy controller makes use of the symptoms and rules available in the knowledge base 29 which are also used for producing the malfunction diagnosis.

The third fuzzy controller 18b receives the measured value 6b of the redox potential in the feed water upstream of the steam generator 24. The measurement of this measured value 6b represents a redundancy of the measurement of the oxygen concentration at the measuring element 12 at the same point using a different type of measured value, which likewise provides an indication of a troublesome entry of oxygen. As also in the case of the second fuzzy controller 18a, the system deviation 35b and its change 38b are formed in the preprocessing stage 34b associated with this third fuzzy controller 18b and are subsequently fuzzified in the processing stage 36b. With the assistance of the symptoms and rules present in the knowledge base 29—which are also used for producing the malfunction diagnosis—the third fuzzy controller 18b calculates a regulating intervention 21b with respect to the final controlling element 17 of the hydrazine metering device 23. In this case, the third fuzzy controller 18b initially calculates a fuzzified manipulated variable 41b, which is then converted into a sharp value for the regulating intervention 21b in a processing stage 37b.

The fuzzified manipulated variables 41a, 41b, 41c calculated by the three fuzzy controllers 18a, 18b and 18c are subsequently defuzzified in the processing stages 37a, 37b and 37c and fed forward as sharp manipulated variables 21a, 21b and 21c to an element 33 arranged downstream of the three fuzzy controllers for maximum value formation. The greatest value present at this element 33 from the values of the regulating interventions is switched through and acts on the final controlling element 17 of the hydrazine metering device 23. To increase the reliability with respect to corrosion resistance, an excess hydrazine fraction 30 may also be added in advance. The selection of the maximum value from the three calculated regulating interventions and the addition of an additional excess hydrazine fraction 30 then provide an adequate safeguard against corrosion of important components of the water-steam cycle 22 of a technical facility, without an unnecessarily large hydrazine buffer already having to be kept in reserve in normal operation in the water-steam cycle 22. The hydrazine metering continues until the size of the hydrazine buffer in the water-steam cycle reaches a specified value or deviates from it by a still tolerable amount.

Regulating is understood in this context as meaning an intervention in a technical facility which ensures that a monitored variable remains in a specified tolerance band.

1. A method for operating a technical facility with an expert system (1) for diagnosing (9) the operating state of the technical facility (2) characterized by the following steps:
a) in the expert system (1), a malfunction is identified, automatically triggering a regulating intervention in the technical facility;
b) at least one knowledge base (WB) available in the expert system is used—in parallel with the diagnosis (9)—to establish the regulating intervention (u);
c) the regulating intervention (u) in the technical facility is continued until the system deviation (e) lies in a specified tolerance band.

2. The method as claimed in claim 1, characterized in that the expert system (1) produces the diagnosis (9) by means of measured values (6) and the regulating intervention (u) is established at least from one of the measured values (6) and/or a variable derived from the measured values (6).

3. The method as claimed in claim 2, characterized in that the system deviation (e) and/or the change (de) in it is formed as variables derived from the measured values (6).

4. The method as claimed in one of claims 1 to 3, characterized in that the regulating intervention (u) is completely established by means of the knowledge base (WB).

5. The method as claimed in one of claims 1 to 4, characterized in that the knowledge base (WB) of the expert system (1) is formulated according to methods of fuzzy logic.

6. The method as claimed in claim 5, characterized in that the fuzzy logic contains specific, linguistic IF . . . THEN rules.

7. The method as claimed in claim 5 or 6, characterized in that the system deviation (e) and/or variables derived from it are fuzzified.

8. A hydrazine metering device for a water-steam cycle (22), characterized by
a first measuring element (14) for ascertaining a first measured value (6c) of the oxygen concentration in the feed water downstream of a condenser (26),
a second measuring element (12) for ascertaining a second measured value (6a) of the oxygen concentration in the feed water upstream of a steam generator (24),
a third measuring element (13) for ascertaining a third measured value (6b) of the concentration of hydrazine in the feed water upstream of the steam generator (24),
an expert system (31), which receives as input signals at least the measured values (6c, 6a, 6b) ascertained by the measuring elements (14, 12, 13), for producing a malfunction diagnosis with respect to an undesired entry of oxygen into the water-steam cycle (22) by means of symptoms (S) and rules (R) present in the knowledge base (29),
at least a first, a second and a third fuzzy controller (18c, 18a and 18b),
the first fuzzy controller (18c) being fed the first measured value (6c) and also a corresponding first setpoint value (32c),
the second fuzzy controller (18a) being fed the second measured value (6a) and also a corresponding second setpoint value (32a), and
the third fuzzy controller (18b) being fed the third measured value (6b) and also a corresponding third setpoint value (32b),
by means of the fuzzy controllers (18a, 18b, 18c), a regulating intervention (21a, 21b, 21c) with respect to a final controlling element (17) of a metering device (23) for hydrazine is calculated on the basis of a malfunction diagnosis produced by the expert system (31), by means of at least the first, the second and the third measured value (6c, 6a, 6b), using the symptoms (S) and rules (R) present in the knowledge base (29), and
a maximum-value selection element (33), by means of which the intervention of the greatest value is selected from the regulating interventions (21a, 21b, 21c) and switched to the final controlling element (17).
